(19) United States
(12) Patent Application Publication
(10) Pub. No.: US 2010/0166990 A1
(43) Pub. Date: Jul. 1, 2010

(54) ROTATIONALLY MOULDED PRODUCTS AND MOULDS

(76) Inventor: Charles Caulder Bree, Mercer (NZ)

Correspondence Address: YOUNG & THOMPSON, 209 Madison Street, Suite 500, Alexandria, VA, 22314, US

(21) Appl. No.: 12/598,165

(22) PCT Filed: Apr. 30, 2008
(86) PCT No.: PCT/NZ2008/000096

§ 371 Date: Nov. 23, 2009

(30) Foreign Application Priority Data
Apr. 30, 2007 (NZ) 554852

(51) Int. Cl. B32B 27/14; B28B 1/20; B32B 3/10

(52) U.S. Cl. 428/35.7; 264/114; 425/435; 428/137

(57) ABSTRACT

A rotational moulding process replicates a product by conveying fusible materials of one or more compositions during a moulding procedure through an opening into a heated mould rotating in one axis inside an oven. Large products are feasible. A multi-layered product wall is constructed using for example an optionally dyed exterior and foaming granules in a middle layer. A bell-shaped product capable of conversion into a dwelling is made in this manner inside a metal mould, open at one end and slowly rotating about a horizontal axis in an oven.

### FIELD

This invention relates to the general field of rotational moulding, with particular application to apparatus and methods for large-scale rotational moulding and to the provision of large moulded products.

### BACKGROUND

Rotational moulding is a well known technique for moulding plastics such as polyethylene without the equipment needed for techniques such as injection moulding. Typically a heatable steel mould is partially filled with an appropriate amount of powdered plastics material, closed and heated while being rotated and tipped end to end. Powder contacting the heated inner walls of the mould will melt and fuse, sticking to the wall, and the combination of rotation and tipping ensures that the powder eventually contacts and coats every internal surface of the mould, making a continuous and complete plastic wall with a completely enclosed internal cavity. As heating continues, remaining powder in the internal cavity is in turn melted and fused onto the material already stuck to the walls of the mould, tending to stick more readily to areas with only a thin coating of material, which are correspondingly hotter than areas which are already thickly coated. By this means a relatively even, continuous wall of plastics material is built up. The mould continues to be heated, rotated and tipped until all the powder is considered to have melted and been fused. The mould is then cooled. As the plastics material sets it parts from the walls, and the article can be removed. Conventional rotational moulding methods and apparatus have been found to work well for products up to about 1 metre in any dimension, but a number of difficulties arise when the method is used with larger-scale products. The mechanical strain on the tipping apparatus becomes considerable as the weight of the mould and the weight of the powdered plastics material in it increases. A large-scale article of more than 1 or 2 metres in each dimension might require a substantial weight of powdered material, and considerable strain is put on the rotational bearings and other supporting structures as this weight is lifted and poured from one end of the mould to impact against the other, particularly in the early stages of the process when the bulk of the powder is unfused and still mobile within the chamber of the mould.

The tipping and rotating mechanism accordingly needs to be very heavy and robust. Even so, it can be subjected to high wear and require frequent repair or replacement of parts. The whole mechanism needs to be elevated or operated over a pit, to allow clearance for the ends to be tipped up and down, which adds considerably to the difficulty involved in getting powdered material up into the mould, and getting the finished product out again.

The mould is fully enclosed and the internal cavity of the moulded article is soon sealed off since all walls are coated with fused material. Accordingly it is difficult to ascertain the progress of the fusing process in the interior. In particular it is difficult to test whether all the powder has melted, and difficult to know whether convoluted or complex details of the mould have been adequately filled and coated or whether the material is applying itself evenly to all surfaces. The amount of powder put into the mould must be accurately calculated and measured from the beginning, because there is no possibility of adding further material once the process has started, or of removing surplus material.

When the moulding is finished, it is not possible to vent or access the internal cavity of the product, which is a fully enclosed form, and cooling of the material accordingly happens from the outside in. When the outer surface of the product cools and sets it can detach from the interior surface of the mould, but because the interior is not yet fully set the wall may not be strong enough to support its own weight. The weight of the material may cause the walls to sag, pucker or otherwise distort before the whole thickness sets. This deformation is particularly difficult to avoid with larger products where the thickness and weight of material is greater, the span across the top of the product is longer, and the thick walls take longer to cool and set. If the product is taken out of the mould too soon it will sag as a whole, but even if left in the mould while setting, the uppermost parts will tend to pull away and collapse downward. If the mould is rotated while setting, this deformation is spread evenly around the product but is not avoided. Deformation of the product while setting can considerably reduce the utility and value of the product, particularly if it is intended to match and interlock with other components in a larger assembly, and requires accurately shaped and aligned lugs, sockets or surfaces.

### OBJECT

This invention seeks to provide an improved method for rotationally moulding large objects, for instance large bell-shaped structures that are easily convertible into dwellings, while in any case this invention seeks to at least provide the public with a useful choice.

### STATEMENT OF INVENTION

In a first broad aspect the invention provides a method for forming a product from at least one particulate thermoplastics material including optional additives (herein called a mixture) by a type of rotational moulding (the moulding process), the method including the steps of (a) constructing a heatable, thermally conductive, rotatable mould having a heated surface and a shaping surface; the mould providing at least one aperture for accepting controlled delivery of mixture during the moulding process; (b) placing the mould inside a heat-retaining envelope or oven along with means capable of rotating the mould during the moulding process, (c) conveying an amount of the mixture to the mould during an extended period, (d) verifying that the mixture is distributed over the shaping surfaces; (e) waiting for the mixture to have fused to underlying hot materials (or on to the shaping surface of the mould itself) before delivering further amounts of the mixture, and (f) after sufficient mixture has accumulated by a process of fusion to underlying hot materials, allowing the oven to cool, stopping the rotation, and retrieving the cooled product from the mould.

Preferably the axis of rotation of the rotatable mould is approximately horizontal.

In a first alternative, a method for forming a layered product by a version of rotational moulding is provided having the steps of (a) conveying a first mixture having a first composition to the mould, (b) waiting for the first mixture to have fused to underlying hot materials, (c) conveying a second mixture having a second composition to the mould, and (d) waiting for the second mixture to have fused to underlying hot materials, until all the intended layers have been fused together, thereby creating a layered structure.

In a related aspect, a first mixture includes a particulate plastics material capable of fusing into a solid mass, optionally together with at least one pigment is followed by a second mixture including additives that cause evolution of a gas when heated and set as a foam, and a third mixture again comprises the particulate plastics material capable of fusing into a solid mass, so that the finished product is comprised of an intermediate foamed layer between non-foamed inner and outer layers.

In a second alternative, a method for forming a product comprised of conjoined portions having distinct properties by a version of rotational moulding is provided wherein the method includes the further step of delivering at least one specified mixture of a first type into a first shaping part of the mould during the moulding process; delivering at least a second specified mixture of a second type into a second shaping part of the mould during the moulding process, and overlaying both separate parts with further plastics material so that the finished product is an integral product yet has distinct portions.

In a second broad aspect the invention provides rotational moulding apparatus, including a moulding chamber or mould mounted for rotation about an axis, having two ends on said axis and conjoined side walls extending between said ends to define an interior space, wherein at least one said end has an axial opening therein capable when in use of providing access to the interior space.

In a related aspect the invention provides apparatus capable of performing the method previously described in this section for moulding a product from at least one fusible particulate thermoplastics material including optional additives (herein called a mixture); wherein the apparatus includes a rotatably mounted thermally conductive mould having a heated side and a shaping side; driving means capable of causing the mould to rotate about an axis of rotation; the mould including at least one aperture sufficiently large to provide continuous access to the shaping side during the moulding process while the mould is being heated and rotated; the mould then being cooled in order to release the product after the product has been formed by complete fusion of sufficient accumulated mixture; wherein the aperture allows the mixture to be delivered by a directable conveyor capable of distributing the mixture over the shaping side of the mould.

In a related aspect, the invention provides at least one product formed by use of modified rotational moulding apparatus as previously described in this section; wherein the at least one product includes at least one aperture that has providing access to the interior of the product; said aperture having been used at least to admit a conveyor means into the interior of the mould during the moulding process.

Preferably the apparatus further includes a conveyor means having an elongated transport tube dimensioned for projection into the interior space of the chamber through said opening, and adapted to convey material for moulding a product into the chamber, when in use.

In one option, the conveyor includes a duct and means for creating airflow along said duct, to blow powdered material for moulding into the chamber.

In another option, the conveyor includes a duct and a screw-conveyor for driving powdered material for moulding along the duct and into the chamber.

Preferably the conveyor includes a duct sufficiently long to extend from the opening in one end of the chamber to a delivery point from which material can be applied onto surfaces at the other end of the chamber.

Alternatively the conveyor is fitted with a recurving duct dimensioned and arranged to extend into the chamber inside the mould and to discharge material on to surfaces at the near end of the chamber about the aperture into the mould.

In yet another option the conveyor may comprise a hand-held shovel.

Preferably the rotational moulding apparatus has the mould mounted on bearing means supporting, when in use, rotation about an axis, said bearing means including at least one annular bearing ring comprises an annular rail extending around and supported from the chamber, transverse to and centered on said axis; said rail bearing on at least one rotary bearing element such as a wheel, ball or roller, wherein an access to the interior of the chamber is provided within the compass of the bearing ring.

Preferably the annular bearing ring supports one end of the chamber, while an axial rotary bearing supports the other end of the chamber.

Optionally the annular bearing ring is further supported with guide tracks.

In a further aspect the invention provides rotational moulding apparatus including a rotatable moulding chamber or mould having a heated side or surface; the mould being surrounded by a heat-retaining envelope or oven surrounding and spaced apart from the mould; the oven including heating means capable of supplying controllable heat to the heated side of the mould wall to in order to cause fusible material to melt and fuse in the mould interior in use.

Preferably the heat-retaining envelope or oven includes a reclosable access port to allow replenishment or distribution of the fusible material, and access to the completed product.

Preferably the heat-retaining envelope or oven is fixed to a substrate and surrounds the rotatable mould.

Optionally the heat-retaining envelope or oven is fixed to the mould and rotates with the mould.

Preferably the heat-retaining envelope or oven includes at least one baffle to direct flow of hot gas over the mould.

In a third broad aspect, the thermally conductive, rotationally mounted mould presents a conical section surrounding a horizontal axis of rotation, joined to a tapered relatively tubular section, together rotatable in a horizontal axis about the axis of rotation; the mould having a single aperture opening into the shaping surface of the mould: the aperture being as large as an exposed end of the mould.

Preferably the heat-retaining envelope or oven covers at least an upper third of the single aperture by means of an openable heat-resistant and insulating flap or door.

Preferably the thermally conductive, rotationally mounted mould interior has a shape like that of a bell, with dimensions of at least 2 metres diameter and 1.5 metres along the axis.

More preferably the dimensions are about 5 metres diameter and about 3 metres along the axis.

In a fourth broad aspect the invention provides a product comprising a rotationally moulded housing structure, comprising a substantially conical roof section and a tapered, conjoined wall section extending from and continuous with the outer rim of the roof section, wherein the diameter of the wall section is tapered outwardly from the roof section down to a foot; the housing structure being rotationally molded from a fusible plastics material according to one or more previous statements in this section.

Preferably the product is comprised of layers; the outer and inner layers are at least 4 mm in thickness, and the core layer is at least 10 mm in thickness.

Preferably the roof section and the wall section are substantially cylindrical although polygonal and asymmetrical products may be made.

Preferably the housing element is subsequently provided with at least one frame component, comprising a lintel and frame adapted to be fixed into an aperture in the wall section, having a rebate dimensioned to engage with the wall section and an interior flange arranged to contact the inner layer of the wall section when so engaged in an aperture in the wall section, thereby allowing an opening to be cut through the wall and a door or window installed therein.

In a major aspect, the invention provides means for moulding a planar product, wherein the apparatus includes a thermally conductive mould having a predominantly flat shaping surface within a peripheral rim; said mould being rotationally mounted about a vertical axis of rotation inside an oven comprised of (a) means supplying controllable heat and (b) a thermally insulating envelope surrounding the upper aspect and the sides of the mould and thereby capable when in use of retaining heated gas around the mould; the thermally insulating envelope being capable of sideways movement so as to provide, when in use, either an aperture capable of admitting a directable conveyor capable of placing the mixture about the shaping surface of the mould while the mould is being heated and rotated; or, at the end of product formation when the product has been formed by fusion of the mixture, the thermally insulating envelope being capable of being moved away from the mould thereby allowing removal of the product.

In a related aspect the invention provides means for moulding a circular planar product.

In a further related aspect the invention provides a circular planar product comprised of a fused mixture.

These and other aspects of the invention may be made apparent in the following description of preferred embodiments, with reference to the accompanying drawings.

### PREFERRED EMBODIMENT

The description of the invention to be provided herein is given purely by way of example and is not to be taken in any way as limiting the scope or extent of the invention. Note that in this specification unless the text requires otherwise, the word “comprise” and variations such as “comprising” or “comprises” will be understood to imply the inclusion of a stated integer or step or group of integers or steps but not the exclusion of any other integer or step or group of integers or steps.

### DRAWINGS

FIG. 1: shows a first rotational moulding apparatus of the invention in side view and section, with a first conveyor for applying material for moulding at the far end of the mould.

FIG. 2: shows the apparatus of FIG. 1 in end view, with the end door removed.

FIG. 3: shows the apparatus of FIG. 1 with a second conveyor for applying material for moulding at the near end of the mould.

FIG. 4: shows a second rotational moulding apparatus of this invention in side view and section, near the beginning of the moulding process.

FIG. 5: shows the apparatus of FIG. 4 later in the moulding process, with an oven surrounding the apparatus.

FIG. 6: shows a housing structure produced by the moulding apparatus of FIG. 4.

FIG. 7: shows a doorway component for use with the housing structure of FIG. 6.

FIG. 8: shows detail of the wall structure and connection of the doorway component to the wall of the housing structure.

FIG. 9: illustrates stacking of the housing structures for transport or storage.

FIG. 10: shows two housing structures incorporating doorway and window components as in use.

FIG. 11: shows in perspective a mould used for rotationally forming a flat disk suitable for a floor for a housing structure.

FIG. 12: is a section through a mould used for rotationally forming a flat disk suitable for a floor for a housing structure.

FIG. 13: shows in perspective an insulating, mobile enclosure for holding heat in and around the mould used for rotationally forming a flat disk.

### INTRODUCTION

This invention describes a form of “open rotational moulding”. In principle, a metallic object (the mould) heated on one side, and having a shaping side on the other, determines the shape of the product to be made. Unlike the conventional forms of rotational moulding, there is normally no tilting action in “open rotational moulding”, just slow rotation in one axis. There is means to deposit and spread a fusible powdered plastics material over the shaping side surface while it is hot, means to ensure that the heated surface is maintained hot, and when the formation sequence is over; when sufficient material has been laid down and has fused together as required, the heated surface is cooled. The product that has been formed will contract more than the mould itself does and part from the surface. A release agent is generally used to coat the shaping surfaces.

The fusible powdered plastic material is preferably a polyethylene plastics material; for example ICORENE 3840 made by ICO Polymers, Inc of the USA (example distributors: ICO Courtenay). This is a Linear Medium Density Polyethylene plastic material. Various resins with different characteristics may be used, such as alloys based on the same ethylene with varied comonomer (hexene, butene or octene) raw materials, as is known to those skilled in the art. Such materials are obtainable in both solid-setting and foam-setting versions. According to the present invention the operator can apply multiple layers in a sequence, hence forming a product which has (for example) an outer solid skin, an intermediate foamed layer incorporating gas bubbles, and an inner solid skin as well, thereby compromising between strength and weight while adding to insulating properties.

### Example 1

### General Moulds

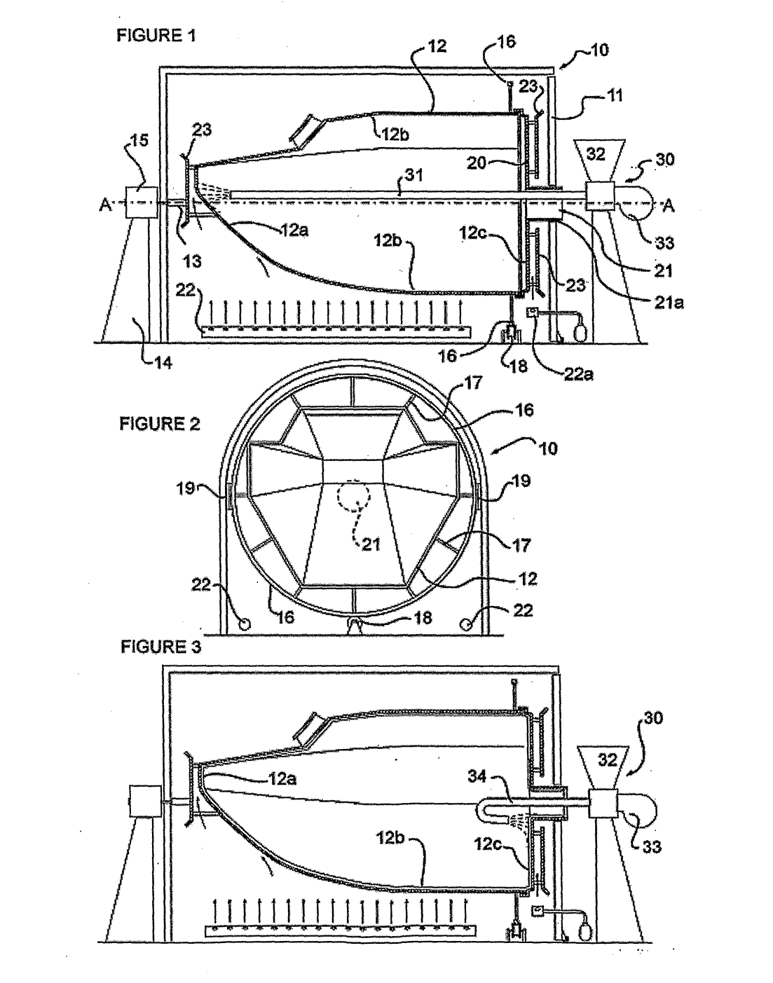

In one preferred form the invention provides rotational moulding apparatus particularly suited to the production of large-scale products. As shown in FIG. 1 a mould for making a section of a boat shall be described first since this is a familiar object. The apparatus includes an insulated oven 10 having a door 11 at one end, in which a mould 12 is mounted for rotation about a horizontal axis indicated by broken line A. The mould is not normally arranged to also continually tilt during a manufacturing process, i.e., the rotation axis A—A of the mould is preferably fixed in a horizontal orientation although this might be altered from time to time, perhaps during a formation sequence, in order to control the relative coating density of different parts. Such a mould might be 2 metres or more in height and width, and 4 or more metres in length, although clearly these dimensions will be varied to suit the specific requirements of the product. In common with prior-art moulds, heat is carried through the walls of the metallic mould itself from the surrounding oven in order to 265 cause fusing together of the plastic granules within.

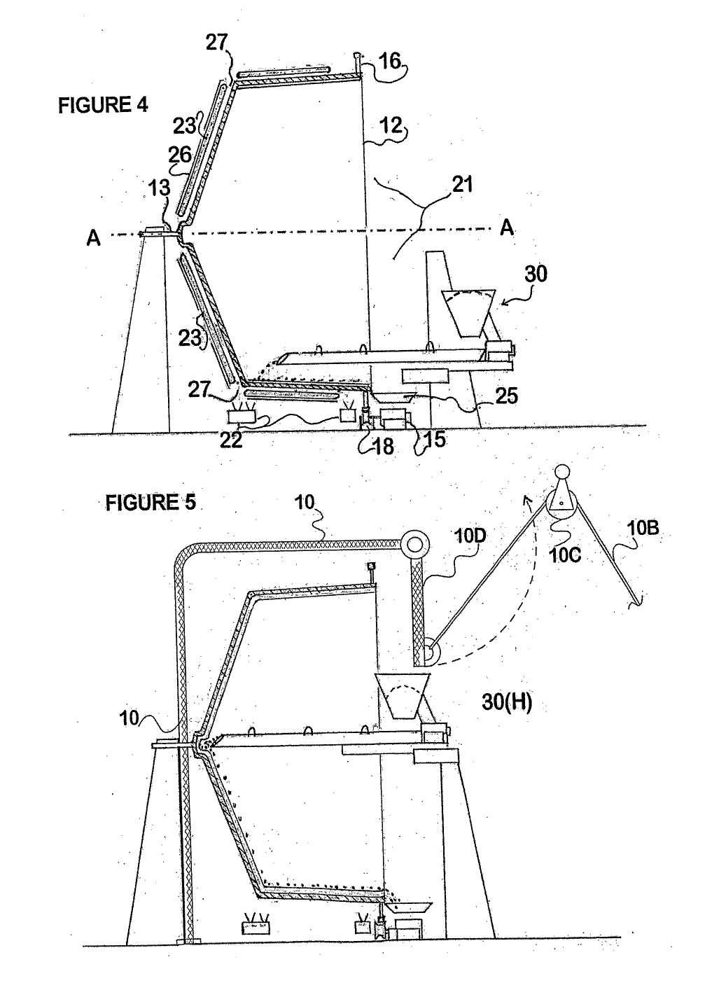

At the end of the oven 10 furthest from the door 11, the mould 12 is mounted on an axial spindle 13 supported on a mounting 14, which may be driven to slowly rotate the mould 12 by a motor 15 or other drive mechanism as shown. At the openable end of the oven 10 however, the mould 12 is supported by a peripheral ring 16, within which the mould 12 is braced and supported by struts 17. The ring 16 is supported by a bearing wheel 18 at the base of the oven, and preferably also by a pair of guides 19 positioned at either side of the oven, as shown in FIG. 2. The ring 16 and the mould 12 are accordingly able to spin freely about the axis A, supported on the spindle 13 at one end and the bearing wheel 18 at the other. The bearing wheel 18 may be driven to rotate the mould 12 by a motor 15 (as shown in the embodiment of FIGS. 4 and 5) as well as, or instead of the axial drive as shown in FIG. 1. It will be appreciated that a motor rotating the mould 12 from the periphery of the mould rather than the centre requires less torque and comes under less strain, particularly if the mould is not symmetrical. A reasonably positive (non-slip) drive system acting on the wheel 18 is therefore currently preferred over an axial drive, although either or both could be used.

The peripheral ring 16 and bearing wheel 18 provide a support structure which allows the mould 12 to rotate, while allowing clear access along the rotational axis A from that end. The mould 12 is formed with an openable door or cap 20, which may be rotatably mounted on the door 11, or simply fastened onto the main body of the mould 12. The cap 20 and the door 11 are provided with a central opening 21, allowing access to the interior of the mould 12 from outside the oven 10. The opening 21 is preferably provided with a sleeve 21a extending from the cap 20 through an aperture in the door 11 along the rotation axis A, but could alternatively comprise simple aligned axial holes in the cap 20 and door 11.

The mould 12 is heated with gas or diesel-fueled burners 22 whether within or directed into the oven 10. These are illustrated only schematically, and it will be appreciated that the particular form, positioning and arrangement of burners will vary according to the size and shape of the mould 12, the wall thickness intended for the product and the moulding material used. Electrical or other heating means might alternatively be used. It is usually preferable to not directly heat the plastics granules in the interior of the mould, but to rely on conduction of heat through the wall to cause the granules to be converted into a rigid structure. The mould oven 12 may be provided with one or more baffles 23, comprising a second wall spaced from and substantially parallel to the mould wall, to guide and trap heated air across the outer surface of the chamber wall in use. Again, the arrangement of these baffles may vary considerably depending on the form of the mould 12, but preferably they are provided on and around the end walls and/or other surfaces extending vertically or transversely relative to the rotational axis A, where the mould wall is further from the burners 22 and the heat of the burners does not directly bear on the mould wall. In particular, a heat-guiding baffle 23 may be provided on the cap 20 to direct heat across the expansive vertical surface there, with a peripheral inlet and an outlet vent near the sleeve 21a at the central opening 21. A dedicated burner 22a may be provided to direct heat in this region, with a gas supply and/or control provided outside the door 11, so that heat in this area can be independently controlled.

It will be appreciated that the article being molded has an open end or at least an aperture providing access to its interior in one end. A conveyor 30 is used to carry powdered material for moulding into the internal cavity of the mould 12 through the opening 21, while the mould is being heated and rotated. The material may vary, but preferably a powdered polyethylene (PE) or other plastics material formulated for use in rotational moulding is used. By this means, the material can be introduced into the mould 12 gradually as moulding progresses rather than all being shut into the mould from the beginning of the process. The conveyor 30 comprises an elongate pipe 31 which projects into the mould 12 along the rotational axis A, connected to a feed hopper 32 and a blower 33 outside the oven 10. In use, the powdered plastics granules are blown into the mould 12 along the pipe 31 by the blower 33, and in most cases is projected onto the far end 12a of the mould 12 at or about the rotational axis A. Material first hitting the surface of the mould 12 at this point will melt, fuse and stick there, but subsequent powder will fall away to run down the end wall 12a of the mould 12 to fuse and stick further from the rotational axis A. As the mould 12 is rotated and powdered plastics granules run further before sticking, the whole of that end 12a becomes coated and then the side walls 12b of the mould 12 also start to become coated. The conveyor 30 could be moved backward by an operator as the moulding process progresses, so as to drop powdered plastics granules directly onto the side walls 12b rather than spraying it onto the end wall 12a, but in any case the side walls 12b are found to be adequately coated by this means. Often, the placement of the conveyor end, and delivery from the conveyor will be controlled by a person.

Eventually all the end wall 12a and side walls 12b will be coated by this process, and a product with a desired wall thickness can be created. The last end wall 12c on the cap 20 however cannot be coated with material using the elongate pipe 31. To coat this wall of the mould, a recurving pipe 34 is fitted to the conveyor 30 and projected into the mould through the opening 21. This pipe 34 allows the powdered plastics granules to be blown back onto the wall 12c of the mould 12 at the rim of the opening 21, from where excess powder can run across and coat the whole of the wall, to join with the material on the side walls at the outer periphery. The dedicated burner 22a will be used at this time to specifically heat the cap 20, to heat the end wall 12c and also the sleeve 21a. The recurving pipe 34 is directed away from the opening 21 so that generally the powdered plastics granules are not projected out of the mould 12 through the opening 21, but some material may nonetheless land on the sleeve 21a, and be fused there. In use this provides a hollow spindle on the molded product which helps support it within the mould as it sets, and which would generally be cut off the final product after removal from the mould 12.

By this means a complete molded form can be created, but with an opening to the interior of the molded product through the axial opening 21. This accessway can allow improvements to the cooling and setting process, and also allows the interior of the cast product to be inspected during the moulding process. This allows an operator to check that all the powder has successfully and completely melted and fused together, and also to see any thin or incompletely covered parts. All products formed by use of modified rotational moulding apparatus according to this invention will include, at least when first moulded, one or more tell-tale apertures providing access to the interior of the product for purposes such as to admit a conveyor means into the interior of the mould during the moulding process.

While the surface of the mould 12 might be at a temperature of 250° C., the internal cavity of the molded product is significantly cooler during the melting and fusing part of the process, because of the energy taken up by the melting of the material. Once the material has been completely melted, the temperature of the air inside the internal cavity rises to match the temperature of the material. Conventionally, the product has been cooled and set by cooling of the mould 12 as a whole, such that the interior material is the last to harden. This can result in significant warping and distortion of the product. However, using the access to the interior provided through the opening 21, cold air can be ducted into the internal cavity of the product and hot air ducted out, such that the interior cools at the same rate or even more rapidly than the exterior surface in contact with the mould walls. The powdered plastics granules stick firmly to the mould walls until caused to part from the mould during cooling, so by this means the walls of the product are kept firmly attached to the mould while a strong interior supporting layer is formed by the set material inside. When the outer surface finally cools and releases from the mould, the shape of the product has already been set and cannot warp or sag.

The apparatus as described above can also be used to create a layered product. The moulding material is introduced into the mould during (not before) the process, so an outer layer of one material, such as solid plastics made of cohered or fused granules, can be formed first, and then when a continuous coating of (for example) 6 mm thickness has been applied to all surfaces, a second layer such as a foamable powdered plastics granules to a thickness of 60 mm can be applied, while the outer layer is still molten. A third layer of solid fused plastics granules might be applied inside that the foamed (bubbled) layer, to create a very strong but light sandwiched wall structure. Because layers are not yet set when subsequent layers are applied, they can easily and strongly fuse together.

Since the product tends to shrink away from the mould as it cools, it is possible to construct pipes or similar objects with parallel walls inside a long mould, perhaps accessing the mould interior with a conveyor pipe from each end rather than just one end, and perhaps using a redistributing device in the early stages in order to ensure that the plastics material is evenly distributed within the mould. It should be noted that this product (the half-boat of FIGS. 1-3; which will subsequently be assembled into a complete boat) had proven impossible to fabricate by rotational moulding without buckling and sagging, prior to development of the oven and mould according to the invention.

### Example 2

### Mould and Product: “The Round House”

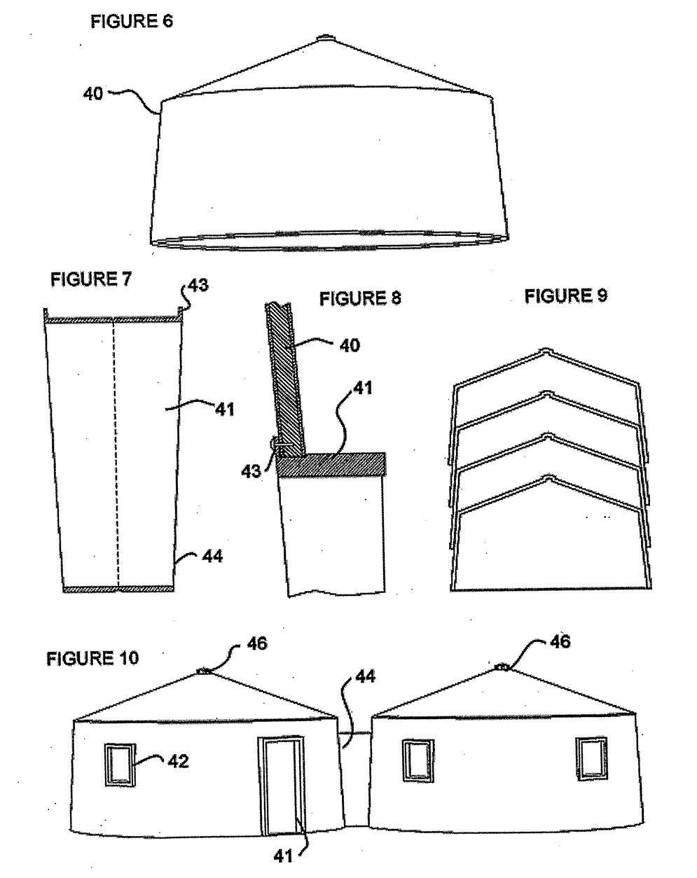

For this example of “open rotational moulding” a large bell-like object shaped like an up-turned cup, with a slightly splayed out rim (illustrated in FIG. 6) will be made. The walls have a diameter of at perhaps 5 metres and a height of 3 metres, for example, which far exceeds the usual limitations of prior-art rotational moulding practice. The house walls are slightly conical so that the product can be stacked easily. Also, a conical shape helps in removal of the parted product from the mould. In this Example, as shown in FIGS. 4 and 5, the mould 12 may be left entirely open at one end, such that the axial opening 21 comprises the whole end of the mould, supported by the peripheral ring 16 and bearing wheel(s) 18 as described with regard to the first embodiment above. More than one peripheral ring may be used, and in that case the axial mounting 13 becomes redundant. This arrangement provides very easy access to the product, through its open base, during moulding. Excess powder running out through the open end of the mould can be caught in a tray 25 and returned to the hopper 32 of the conveyor 30.

As shown in FIG. 4, baffles 23 may be used beneath the interior heat-insulating lining 10 comprising the oven, over substantially the whole outer surface of the mould. These may comprise a second skin spaced away from the mould wall 12, with insulation materials 26 applied to the outside of the baffles, such that the mould itself comprises the oven. A separate heat-insulating envelope 10 is preferred. As shown in FIG. 5, the heated side of the mould is simply exposed to the hot gases inside the oven, and the open end is closed by means of a insulating, heatproof door 10D, swung along its upper edge (a dotted arc shows its travel), that holds the heat inside at least the upper third of the mould and preferably covers the upper two thirds or even more. The door 10D is lifted (such as by rope 10B passing over pulley 10C then down to an anchor) for inspection, for plastics granules distribution, and for releasing a finished product at the end of a production cycle. Burners 22 or other heating means create heated airflow between the baffles 23 and the mould wall through inlet and outlet vents 27. By this means a very simple and cost-effective moulding apparatus is provided. The conveyor 30 may take a variety of forms, as previously described.

The apparatus of FIGS. 4 and 5 is suited to manufacture a round house although the preferably circular structure could be square, octagonal or any of a range of other shapes, symmetrical or not. In particular, the apparatus is used to cast a housing structure 40 as shown in FIGS. 6 to 10, comprising a one-room round building 5 metres in diameter and 3 metres in height. Smaller round buildings could be about 2 metres diameter and 1.5 metres in height. There is no particular dimensional requirement apart from those arising in transport.

As shown in FIG. 4, the screw-conveyor can be used to first pour a layer of one colour of material on the walls of the structure only, to create (for example) a white wall, and then as shown in FIG. 5 the conveyor can be shifted up Pto position 30(H) so as to be aimed at the centre of rotation, in order to pour material perhaps including a pigment of some other colour down from the centre of the far end 12a, to create a terracotta-coloured roof. The terracotta-coloured layer will run onto and behind the white layer to fuse firmly to it, but will be masked by it, to provide sharply edged contrasting colours. That assumes that colors are required. The plastics material itself will not need painting until after many years of weathering. Then, having formed a fused external layer both on the sides and on the roof, the inventor prefers to add a foamed layer in the interests of lightness, thermal insulation as an “R” value, and strength. This foamed layer is constructed simply by changing over to a foam-producing version of the granulated plastics material as provided by the suppliers. Internal to the foamed layer, and hence last, is a further fusible, not foamed layer of preferably a light or even a white colour (in order to maximise the effect of lighting at night) that is applied over the whole, such that the interior of the structure is lightly coloured and smooth throughout. The wall thickness can be varied considerably, depending largely on the heat applied to the mould, but with a sandwiched PE foam structure as described above might be anything from 25 mm to 80 mm in total thickness. The heat insulation property of the finished structure can therefore be modified according to the invention, to suit a particular climate or application.

Since the operator has control over the distribution of powder he or she could allow some areas to be built up to a greater thickness, or otherwise varied to suit the nature of the product. For example the rim at the base may be made stronger if it is found that this can be broken during shipment. The centre of the roof is typically opened and will become a ventilation aperture. The housing structure 40 preferably has a central cupola 46 at the top of the roof, which can be cut to create vents or a chimney. A thickened roof rim or an embedded structure may be provided as a lifting point—for example by a crane or helicopter. The tapered walls provides stackability: the houses may be shipped to a destination stacked one inside another as in FIG. 9, using the tapered walls, up to a convenient weight or height limit. Each house weighs about 500 kg, each floor weighs about 270 kg.

Door frame 41 (FIG. 7) and window frame 42 components can be made to suit the wall thickness, as shown in FIG. 8 (section through wall 40 with door frame 41 attached), each component having a flange 43 around the interior rim. On arrival at a site, a carpenter using a hand saw or preferably an electric circular saw (“skilsaw”) can easily cut rectangular apertures in the basic product 40 for doors 41 and windows 42 as and where necessary by sawing through the plastic wall, and install the necessary joinery and door frame-preferably so that the door swings on a vertical axis. Other services such as electricity and plumbing may be added. Several individual house products could be joined together with passageways (see passageway 44; which may be two door frames end to end, in FIG. 10). The floor of the house may be provided from the same material as the walls and roof (see example 3, below) which is welded or otherwise attached to the lower edge of the wall. The disk may sit upon the ground (previously scraped flat) or may be insulated from the ground or raised above the ground, (even above water) on a raised foundation so that (for example) animals and other possessions can be kept underneath the house. An alternative floor for the dwelling 40 may be made of slats or a continuous solid wooden or composite floor.

One application for these round houses is as secure refugee shelters or as emergency shelters to be provided by a welfare agency after a population has experienced a natural disaster such as an earthquake, tsunami or flood. Another application is as a beach house.

### Variations of the Example 2 Mould.

Longer moulds for longer or taller products might be supported on peripheral supporting rings and associated bearing wheel at both ends and perhaps extra supports are provided in between, and such moulds may have axial openings at both ends to further give access to the interior. Such a structure could be used' in moulding pipes.

The mould 12 and its supporting structure, including the bearing wheel 18, axial spindle 13 and mounting 14, and drive motor 15, may all be mounted on a trolley to allow removal from the oven 10. This would allow easy access to both the mould 12 and the interior of the oven 10, burners 22 and the like, and Speed the cooling process. It is currently preferred that a dedicated oven be built specifically for each mould 12, but alternatively a range of moulds could be used in the same oven, being inserted and removed along with the support structure on the trolley, as required.

While it is preferred for the rotational axis to be horizontal, it might be fixed at a different angle. In particular, if the rotational axis were set at a slight downward slope towards the open end of the mould it might facilitate flow of powder along the side walls of the mould, and/or removal of the finished product from the mould.

### Example 3

### A Mould for a Floor for the Round House

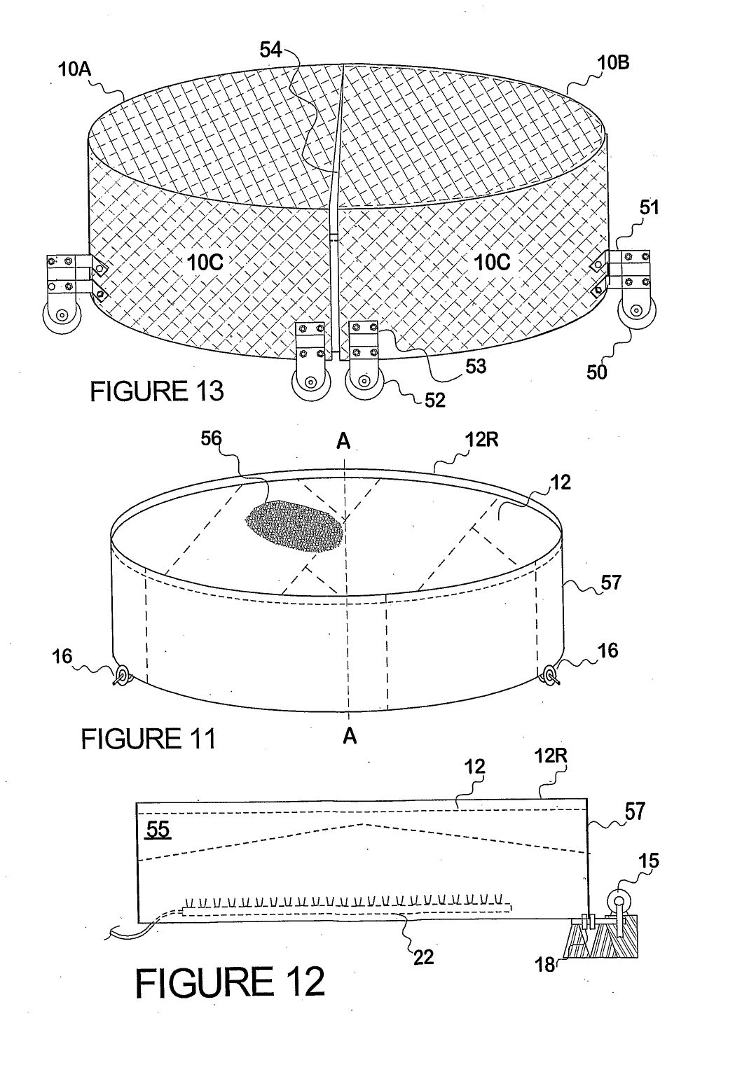

This version of the invention (see FIGS. 11-13) moulds a flat sheet: in this case a disk for use as a floor of a round container or house. The example describes a circular disk. Other shapes can be made. This disk is typically 20 mm thick and about 5 metres in diameter, or whatever diameter the round house (see above) will be. In this case, rotation about a vertical axis serves to present different parts of the hot mould to an operator in turn for granules replenishment, while keeping most of the mould hot underneath an insulating jacket and helping to distribute the heat evenly.

In order to make the mould, a non-perforated steel sheet surface, a shaping surface 12 is constructed by welding edges of individual sheets together (dotted lines in FIG. 11 indicate edges). A few granules on top of the shaping surface are at 56. The exposed sheet edges are cut to a reasonably accurate circular profile. The disk mould is then provided with a vertically dependent, circular welded rim 12R that extends above the steel sheet surface by about 20-30 mm and downwards (as skirt 57) by about 45 cm terminating in a flat edge. A working site in a place substantially free of draughts is desirable. The rim is supported a small distance above a fire-resistant floor (such as concrete), when in use, by a set of fixed wheels 16, 16, and a motor-driven wheel 18 (lying in plane A-A of FIG. 11, shown in FIG. 12) all able to roll against the welded rim, causing the rim to turn while retaining it in place in a horizontal plane. Wheels having flanges like V-belt pulley wheels, or motor 500 vehicle wheel hubs may suffice. Internal beams and stiffeners 55 are preferably provided beneath the circular surface of the mould so that there is no sag of the surface towards the centre, when it bears the weight of the plastic material or of persons cleaning the surface from time to time. Such stiffeners may raise heat flow where they are attached beneath surface 12, so it may be useful to cover them with thermal lagging.

The mould is heated by burning fuel beneath at a controlled rate through burner 22, while the mould is slowly rated perhaps at about 1 or 2 revolutions per minute using a driving wheel 18 powered by an electric motor 15 or other driving means (for example a treadmill or animal power). A preferred fuel is diesel oil since it is readily available and is possibly safer in inexperienced hands than is compressed or liquid gas. Electricity is usually more expensive. The desired temperature is that which will slowly cause a coating of plastics granules placed on top of the disk to melt and co-adhere into a single mass, as is known to persons skilled in the art of rotational moulding. As with conventional types of rotational moulding, further granules applied later are fused with the already melted granules until a sufficient thickness builds up. An operator would know when the job is done by having consumed a fixed (we-weighed) total amount of granules in the job. The operator physically sprays the mould surface with fusible plastic granules using a conveyor device (as previously described (30, 31, 32 in FIG. 1) that transportss granules from a hopper 32 along a delivery pipe 31 to an open end, by blowing 33 or by using an auger screw turned by a low-speed motor or a hand crank. As required, the operator or an assistant rakes or screeds the granules covering the hot disk into an even surface of slowly fusing granules; fusion starting at the bottom nearest the heated mould. A middle layer of foamed material may be constructed as previously described, by use of suitable plastics granules. This deposition process is continued over an extended period of time, perhaps over several hours. Once the top surface has fused into a contiguous, void-free mass, the process is complete. The heating is stopped. After a period of time the plastics mass will contract and separate from the steel surface and rim, and when it is safely cool and sufficiently hard it may be removed and used.

FIG. 13 shows heat entrapment means—a form of oven 10. The entire mould is located beneath a circular insulating blanket made of rock wool, fiberglass, or other high-temperature insulating materials made in two parts 10A, 10B with sides 10C extending 530 almost down to the floor. The two halves are capable of being closed together over the top of the mould. Having two half-circles 10A, 10B separately mounted by support brackets 51, 53 on parallel wheels 50, 52 allows one part to temporarily be moved apart from the other during moulding thereby exposing an access slit or sector that extends from the operator's position past the centre such as for the addition of, or redistribution of plastics granules. Both sides are pushed aside when the finished disk is cooled and ready to be removed. Without the envelope, the extra necessary flow of heat through the steel disk and through the existing amount of plastics material would overheat the lowest layer while losing too much heat to the space above by radiation and convection, and fusion of the complete layer would not be achievable. A space between the covers and the floor below is permissible, because hot air tends to rise and because air is required for combustion.

A non-circular flat shape may be made by welding a second rim-like metal boundary having a desired shape and dimensions on to the flat surface inside the rim described as 12A, and after use recycling any plastics material that was deposited outside the second boundary.

### Variations

The approach to rotational moulding as described allows a wide variety of products to be made, to suit different purposes and applications. For example, cubic or other straight-sided units could be made as a modular housing unit intended to be built up room by room. There is no requirement that the rotationally molded products be actually round, although round products are easier to make and are inherently stronger than for example, square housing units. Other heat-settable materials could be used, and/or other components such as fiberglass matting and embedded electrical cabling could be introduced into the molten material, possibly between layers, to alter the strength or other properties of the material. Plain steel moulds may rust and deteriorate or transfer rust to the moulded products. Other. conductive materials may be used, such as stainless steel.

Although the text assumes that a human operator will operate the conveyor so as to distribute the powdered plastics material evenly, and that will remain an adequate method in technologically deprived environments, it is possible to use robotic control and machine vision techniques in order to deposit the plastics granules.

### INDUSTRIAL APPLICATIONS AND ADVANTAGES

The invention allows rotational moulding of very large-scale products in plastics materials such as polyethylene without distortion, and could accordingly be used to mould products such as large-diameter pipes for sewerage or storm water applications, tanks for transporting or storing liquids, boats, docks and other floating structures.

Multiple layers in the product walls can be constructed, such as foamed layers, simply by changing the type of fusible granules. Selective colouring and thicknesses of various parts can be obtained by manipulation of the powder delivery conveyor.

Finally it will be understood that the scope of this invention as described and/or illustrated herein is not limited to the specified embodiments. Those of skill will appreciate that various modifications, additions, known equivalents, and substitutions are possible without departing from the scope and spirit of the invention as set forth in the following claims.

I claim:

1. A method for forming a product from at least one thermoplastics material (herein called a mixture) by a type of rotational moulding (the moulding process), the method including the steps of
(a) constructing a heatable, thermally conductive, rotatable mould having a heating surface and a shaping surface; the mould providing at least one aperture for accepting controlled delivery of material during the moulding process,
(b) placing the mould inside a heat-retaining envelope or oven, heating the mould, and rotating the mould during the moulding process,
(c) then conveying an amount of the mixture to the shaping side of the mould during an extended period,
(d) verifying that the mixture is suitably distributed over the shaping side;
(e) waiting for the mixture to have fused to underlying hot material against the shaping surface of the mould while delivering further amounts of the mixture, and
(f) after sufficient mixture has accumulated by a process of fusion to underlying hot material, allowing the oven to cool, stopping the rotation, and retrieving the cooled product from the mould.

2. A method as claimed in claim 1 for forming a layered product by a version of rotational moulding, the method also having the steps of
(a) waiting for a first mixture to have fused to underlying hot materials,
(b) conveying a subsequent mixture having a differing composition to the mould, and
(d) waiting for the subsequent mixture to have fused to underlying hot materials, until all the intended layers have been conveyed into the mould and fused against the shaping surface.

3. A method as claimed in claim 2, wherein a first mixture includes a plastics material capable of fusing into a solid mass, a second mixture also includes materials that cause evolution of a gas when heated and set as a foam, and a third mixture again comprises a plastics material capable of fusing into a solid mass, so that the finished product is comprised of an intermediate foamed layer between non-foamed inner and outer layers.

4. A method as claimed in claim 1 for forming a product comprised of joined portions having distinct properties by a version of rotational moulding, the method including the further step of delivering by controlled conveyor means at least one specified mixture of a first type into a first selected shaping part of the mould during the moulding process; delivering at least a second specified mixture of a second type into a second selected shaping part of the mould during the moulding process, so that the finished product is an integral product yet has distinct portions.

5. Apparatus capable of performing the method of claim 1 for moulding a product from at least one fusible thermoplastics material including optional additives (herein called a mixture); characterised in that the apparatus includes a rotatably mounted thermally conductive mould having a heated side and a shaping side; the mould capable of being driven by driving means thereby causing the mould to rotate about an axis of rotation, the mould being surrounded by a heat-retaining envelope or oven surrounding yet spaced apart from the mould and having controllable heating means capable of supplying heat to the heated side; the mould including at least one aperture capable of providing continuous access to the shaping side during the moulding process such that a directable conveyor is capable of selectively distributing the mixture over the shaping side of the heated rotating mould; the mould being operable after cooling in order to release the product after complete fusion of sufficient accumulated mixture has occurred.

6. Apparatus as claimed in claim 5, characterised in that the thermally conductive, rotationally mounted mould is comprised of at least two joined yet separable parts having a shared axis of rotation; the joined yet separable parts being capable of being separated from each other after the product has been formed and allowed to cool and harden, thereby releasing the product.

7. Apparatus as claimed in claim 5, characterised in that the thermally conductive, rotationally mounted mould is comprised of a tapered tubular interior with one open end, having a shape like that of a bell, rotatable in a horizontal axis about the axis of rotation of the bell; a single, reversibly covered aperture into the shaping surface of the mould being as large as an exposed end of the mould.

8. Apparatus as claimed in claim 7, characterised in that the thermally conductive, rotationally mounted mould is comprised of a tapered tubular interior having a shape like that of a bell, with dimensions of about 5 metres diameter across the open end and about 3 metres along the axis.

9. Apparatus as claimed in claim 5 for moulding a flat product, characterised in that the apparatus includes a thermally conductive mould having a substantially flat shaping surface within a peripheral rim; said mould being rotationally mounted about a vertical axis of rotation inside an oven having (a) means capable of supplying controllable heat and (b) a thermally insulating envelope surrounding the top and the sides of the mould and thereby capable when in use of retaining heated gas around the mould; the thermally insulating envelope being capable of sideways movement so as to provide, when in use, either an aperture capable of admitting a directable conveyor capable of placing the mixture about the shaping surface of the mould while the mould is being heated and rotated; or after the product has been formed by fusion of the mixture, the thermally insulating envelope is capable of being moved away from the mould thereby allowing removal of the product.

10. A product formed from at least one material using modified rotational moulding apparatus as claimed in claim 5, characterised in that the product after moulding retains at least one aperture providing access to the interior of the product.

11. A product as claimed in claim 10, characterised in that the product after moulding is comprised of more than one layer; each layer being comprised of a different mixture.

12. A flat product formed from at least one material using modified rotational moulding apparatus as claimed in claim 9, characterised in that the product is comprised of a fused thermoplastics material and the aperture comprises one entire surface.

13. A flat product as claimed in claim 12, characterised in that the product includes more than one layer of a fused thermoplastics material.
